(19) United States
(12) Patent Application Publication
(10) Pub. No.: US 2025/0137939 A1
(43) Pub. Date: May 1, 2025

(54) VERIFICATION METHOD FOR A BIRD PROTECTION FUNCTION OF A GLASS SURFACE

(71) Applicant: BirdShades Innovations GmbH, Leoben (AT)

(72) Inventors: Christoph CERNY, Leoben (AT); Dominique WADDOUP, Leoben (AT)

(73) Assignee: BirdShades Innovations GmbH, Leoben (AT)

(21) Appl. No.: 18/835,358

(22) PCT Filed: Feb. 2, 2023
(86) PCT No.: PCT/AT2023/060030

§ 371 Date: Aug. 2, 2024

(30) Foreign Application Priority Data
Feb. 2, 2022 (AT) A33/2022

(51) Int. Cl. G01N 21/958; A01M 29/08; G06V 10/143; G06V 10/147

(52) U.S. Cl. CPC G01N 21/958; A01M 29/08; G06V 10/143; G06V 10/147; G01N 2201/102

(57) ABSTRACT

The present invention relates to a verification method for verifying a bird protection function of a glass surface (GO) with at least one bird protection section (VS) effective at least in the UV range, comprising the following steps:
aligning a recording direction (AR) of a camera device (10) with a UV transmission filter device (40) onto the glass surface (GO),
generating at least one camera recording (KA) of the glass surface (GO) with the bird protection section (VS) by means of the aligned camera device (10),
outputting the at least one camera recording (KA) as a bird protection image (VSA) as proof of the bird protection function provided by the bird protection section (VS) visible in the bird protection image (VSA).

The present invention relates to a verification method for verifying a bird protection function of a glass surface, an evaluation method for a bird protection function of a bird protection section based on a bird protection image, a computer program product for carrying out an evaluation method and a camera device for use in such a verification method. It is known that large-area glass surfaces, in particular on building facades or large window surfaces, pose a risk of so-called bird strikes. This means that birds do not perceive such a glass surface as an obstacle, since by reflecting the surroundings and/or allowing a view through to the surroundings behind the glass pane, this glass pane appears to them as a possible flight path. This leads to the birds flying into such a glass surface at full speed and injuring themselves.

It has been known in the past that these bird strikes can be avoided or at least reduced by marking such glass surfaces for the birds in the range visible to humans. For example, it is known for stickers to be used that have a pattern in the visible range to present the glass surface to the birds as an obstacle. The disadvantage of such stickers in the visible range is that they significantly change the uniformity and aesthetics of the glass surface, and are often undesirable, in particular for aesthetic and architectural reasons. Such stickers which are arranged in the visible range also reduce transparency and thus the view through such glass surfaces for the persons present within the building.

It is also known for a bird protection section in a range that is not visible to humans to be applied to such a glass surface. Due to the fact that birds also have a perceptual capacity in the UV range, which is not visible to humans, structures, patterns or the like in this UV range, and thus not visible to humans, can be applied to such glass surfaces as a bird protection section, for example in film form. This means that, while humans cannot perceive such a bird protection section, it can be perceived by birds due to their broader spectrum of perception in the UV range.

A disadvantage of the solutions described above is that the inability of humans to perceive within the UV range means that it is not possible to tell with the human eye whether a glass surface has such a UV bird protection function or not. In particular, if a bird protection function for the glass surface on a building is sensible or even mandatory for reasons of standardisation or nature conservation, this means that an acceptance of the building is not possible due to an inability to perceive the existing bird protection function. In other words, it cannot be recognised with the naked eye whether or not a glass surface has the desired bird protection function, since the presence of a bird protection section with an effect in the UV range does not lie within the visible range for humans.

It is the object of the present invention to remedy, at least in part, the disadvantages described above. In particular, it is the object of the present invention to provide a means of verifying a bird protection function on a glass surface in a cost-effective and simple manner.

The above object is achieved by a verification method with the features of claim 1, an evaluation method with the features of claim 9, a computer program product with the features of claim 16 and a camera device with the features of claim 17. Further features and details of the invention are disclosed in the dependent claims, the description and the drawings. Naturally, features and details described in connection with the verification method according to the invention also apply in connection with the evaluation method according to the invention, the computer program product according to the invention and the camera device according to the invention and vice versa, so that with regard to disclosure mutual reference is or can always be made to the individual aspects of the invention.

According to the invention, a verification method is used to verify a bird protection function of a glass surface with at least one bird protection section effective at least in the UV range. Such a verification method comprises the following steps:
aligning a recording direction of a camera device with a UV transmission filter device onto the glass surface,
generating at least one camera recording of the glass surface with the bird protection section by means of the aligned camera device,
outputting at least one camera recording as a bird protection image as proof of the bird protection function provided by the bird protection section visible in the bird protection image.

A verification method according to the invention basically serves to make visible a bird protection function that is otherwise invisible to humans. As already explained in the introduction, a particularly advantageous bird protection function can be achieved in that it is visible to the bird and not visible to humans. This is achieved by applying to a glass surface a bird protection function with a bird protection section which is only effective in the range that is not visible to humans, namely in the UV range. As a result, as has already been indicated, birds, due to their wider range of perception, perceive a UV reflection and/or UV absorption in the UV range as a bird protection function and accordingly recognise the bird protection section as an obstacle. Due to the fact that the optical effect in the form of UV absorption and/or UV reflection is located in a range of the light spectrum that is not visible to humans, this bird protection function and thus the bird protection section is not optically recognisable to humans.

For the purposes of the present invention, a glass surface is to be understood as any transparent surface, irrespective of the material. In addition to transparent surfaces made of glass material, plastic materials or the like are also conceivable within the scope of this definition.

However, the above functional principle, which is advantageous for birds and humans, leads to the disadvantages described in the introduction with regard to the detectability of the bird protection function. In particular in the case of the acceptance of building structures, glass façades, mirrored façades, window surfaces or other glass surfaces, it is not apparent whether or not they actually have a bird protection function. In particular, it is not possible to tell with the naked eye whether the glass surface is provided with a bird protection section.

According to the invention, detectability is now guaranteed by means of technical aids. A camera device is used as a technical aid, likewise being included in the subject matter of the present invention, as will be explained in more detail later. This camera device differs from known camera devices in that it has a UV transmission filter device, i.e. it is able to allow light in the UV range to penetrate through to a corresponding optical sensor device and filters out light of other wavelengths. In other words, it is thus possible that an optical sensor device, i.e. an optical chip of the camera device, can exclusively record the light spectrum in the UV range. The camera device can in particular be a digital camera device.

In the first step of a verification method according to the invention, the camera device is therefore aligned with the recording direction towards the glass surface. Because it is to be checked whether the bird protection section with a functionality as a bird protection function is actually arranged on the glass surface, this modified camera device is now aligned towards the glass surface and in the next step at least one camera recording is generated. Because the camera device is equipped with a UV transmission filter device, reflected light rays reach the interior of the camera device and onto the optical sensor device exclusively in the UV range, and thus in the light spectrum range that is invisible to humans but visible to birds. The at least one camera recording is therefore generated in a way that replicates part of the bird's perceptual ability, namely in the UV range.

In the last step, the camera recording is output as a bird protection image. If there is a bird protection section on the glass surface with an effect in the UV range, this effect in the UV range is manifested as an optical effect with altered absorption, reflection and/or transmission properties compared to a normal glass surface. In particular, a defined absorption in the UV range is preferred, so that incident UV light falling on the bird protection section is absorbed more strongly and/or reflected outwards compared to the normal glass surface. In the camera recording, which is filtered exclusively to the UV range, this leads to these areas of the bird protection section appearing darker, with increased UV absorption, or brighter with increased UV reflection, since the proportion of reflected UV light is reduced by the increased absorption compared to normal glass surface, or increased by increased UV reflection. In a first step, the actual form of the individual absorption sections of the bird protection section is immaterial. However, the important thing is that this increased absorption and/or reflectance is now made visible to humans on the camera recording as a bird protection function and that this camera recording can therefore be output as a bird protection image. The result of a method according to the invention can therefore be a real and/or a digital image of the glass surface which extends the human perception into the UV range. This is ensured in that, due to the use of the UV transmission filter device, the camera device as an aid is now able to achieve a camera recording which, as a bird protection image, makes the bird protection section with its bird protection function in the UV range visible to humans.

Based on the above explanation, it becomes clear that the verification method with the technical aid of the camera device makes it possible to provide an optical proof, on a glass surface, as to whether a bird protection section is present on the glass surface and whether this existing bird protection section has a corresponding effect in the UV range.

This proof can in particular be primarily qualitative, so that proof of the fundamental existence of such a bird protection section effective in the UV range is provided. However, it can bring further advantages if, as will be explained later, a quantitative statement, for example in the context of an evaluation method, is also part of the use of this bird protection image.

It should also be pointed out that the bird protection section is effective at least in the UV range. Of course, such a bird protection section can also provide additional bird protection functions which are effective in other ranges of the light spectrum, in particular also in the range visible to humans, also referred to as the VIS range.

In addition to a statement simply in the form of the camera recording, such a verification method comprises in particular a preliminary step for an evaluation method, which is also the subject matter of the present invention and will be explained in more detail later. It should also be pointed out that the camera recording, as the subject matter of the present invention, can be both a static camera recording as well as a moving image recording, in particular in the form of a video.

It can bring advantages if, in a verification method according to the invention, the recording direction is aligned with a direction of reflection of the sky from the glass surface. The direction of reflection of the sky depends on the arrangement of the orientation of the glass surface and in particular also on the location of the camera device. An orientation of 45°+−10° is preferred, preferably +−5°, particularly preferably +−3°. Such an orientation is in particular preferred if a later qualitative and/or quantitative comparison with specified values and/or reference values is desired. The more reflected sky included in the camera recording, the more accurately can a subsequent evaluation method be carried out, for example. Cross-influences or cross-reflections, but in particular also cross-reflections from other glass surfaces, can be reduced in this way.

It brings further advantages if, in a verification method according to the invention, the recording direction is in addition aligned with respect to a direction of incident sunlight onto the glass surface. This can be done in addition to or as an alternative to the perpendicular orientation according to the preceding paragraph. The inclusion of the direction of incident sunlight also means that an increase in the light intensity can be achieved. In particular, it is ensured that a reflection can be distinguished from an absorption in the camera recording with the highest possible light intensity in the UV range.

It brings further advantages if, in a verification method according to the invention, a reference section is placed in a recording area of the aligned camera device which, when the camera recording is generated, is part of this camera recording. This allows manual referencing, so to speak. Automatic evaluation with such referencing is also possible, as will be explained later. The reference section serves as a reference in particular from an optical point of view. For example, such an optical reference section has a defined absorption, a defined reflection and/or a defined transmission. If, for example, as will be explained later, an analysis of the bird protection function is to be carried out in quantitative terms, on the basis of a known degree of absorption and/or reflectance of the reference section it is now possible to compare its brightness in the bird protection image with the corresponding brightness of a UV absorption section in the reference section. If the corresponding section in the bird protection section is darker than in the reference section, then the absorption effect is stronger than the known absorption effect of the reference section, and vice versa. For example, the reference section can specify a limit value, for example a minimum degree of UV absorption and/or UV reflection, so that it can then be ensured through the comparison between the reference section and the bird protection section whether or not a bird protection section complies with the desired limit value for absorption from a quantitative point of view. The arrangement in the recording area can be ensured in a variety of ways. For example arrangement on or against the glass surface, in the region in front of or next to the glass surface, but also in the region of the camera device is possible.

It brings further advantages if, in a verification method according to the invention, at least one of the following is used as reference section:
mirror section
glass section
colour section.

The above list is a non-exhaustive list. Combinations of different types are also conceivable in principle for the reference section. Gradients of colour, different glass elements or different mirror sections are also conceivable in principle. An inscription on the reference section, in particular in the range visible to humans, always allows the use and marking of the correct and appropriate reference section. For example, an inscription can be arranged on the reference section in a visible way which describes the degree of reflection and/or absorption in a defined UV range. In addition or alternatively, the same inscription can also be provided in the UV range, so that this is made visible as part of the camera recording.

It is also advantageous if, in a verification method according to the invention, the reference section is aligned parallel or substantially parallel to the glass surface. A parallel alignment of the reference section, which preferably also has a planar extension itself, means that a similar or even identical optical effect is achieved between the camera device and the reference section as is achieved between the camera device and the glass surface. Possible optical differences due to different orientations are avoided here through the corresponding correlation between reference section and glass surface. In particular, this relates to the area of the glass surface in which the bird protection section is located.

It brings further advantages if, in a verification method according to the invention, at least one reference parameter is recorded for at least one camera recording. This can be done in connection with the use of a reference section, but also without a reference section. Such a reference parameter can comprise information about the current weather situation, the light intensity, the angles of incidence of the light or the like. The reference parameter can be measured by corresponding sensors in the camera device. It is also possible in principle to include such reference parameters from other sources, in particular from online databases.

In addition, it brings advantages if, in a verification method according to the invention, in addition to the bird protection image, a camera recording of a reference section is generated and is output as a reference recording. The reference section can be configured and used in the way already explained. In addition to integrating the reference section into the camera recording as a bird protection image, such a recording can also be made separately, for example at a similar time and similar location. In particular if the glass surface can only be accessed with difficulty, this makes it possible to provide a reference section with a reference recording for reference even if it would not be possible to insert this reference section into the recording area of the camera device in alignment with the glass surface, or only with a great deal of effort.

The subject matter of the present invention also includes an evaluation method for a bird protection function of a bird protection section on the basis of a bird protection image, in particular generated using a verification method according to the invention. Such an evaluation method comprises the following steps:
recording the bird protection image of a glass surface with at least one bird protection section effective at least in the UV range,
identifying UV absorption sections and/or UV reflection sections in the bird protection image,
comparing at least one surface parameter of the identified UV absorption sections and/or the identified UV reflection sections with at least one specified surface value,
outputting the comparison result as a bird protection parameter for the bird protection function of the bird protection section.

A method according to the invention is based in particular on a verification method according to the invention. While the verification method is basically content with making the bird protection function, which is not visible to humans with the naked eye, verifiable and visible, the evaluation method goes one step further. The evaluation method can integrate such a verification method or can be based on such a verification method and its result in the form of the bird protection image, independently of the verification method. The bird protection image can be captured by reading, storing or transmission, but also generated using a verification method according to the invention

The core idea of the evaluation method is that an optical evaluation now takes place within the UV range. This optical evaluation evaluates the bird protection image with regard to its absorption function and/or its reflection function. For example, the bird protection section in the bird protection image is divided into different UV absorption sections and/or different UV reflection sections. In other words, an identification step is now carried out in order to be able to distinguish between different partial sections in the bird protection section with different optical functions in the UV range. These sections, which can be distinguished in the UV range, are also perceived in the same way by the bird, so that a comparison of surface parameters of these identified sections can then be made. The comparison can for example include widths, distances, total surface areas or the like. The shape or formal relation can also be understood as a surface parameter in the sense of the present invention. Reference is fundamentally made to experiments or test results showing which surface parameters have a particularly advantageous bird protection function, in terms of correlation and design. To illustrate this with reference to an example, the passage width between two UV absorption strips, as surface parameter, is explained in more detail below.

If the bird protection section is provided with different stripes which have different absorption rates in the UV range, this leads to a stripe pattern in the bird's UV perception which can also be understood as a grid pattern. If the absorption strips are too wide and the spaces between them too narrow, this can lead to the bird perceiving this as a full-surface element, with a reduced probability of being perceived as an obstacle. If the sections between the different UV absorption strips are too large, small birds may perceive these as passages which would form a kind of flight path. In both cases, a passage width that is too large or too small would be associated with a reduced bird protection function. Thus, for example, a maximum distance and/or a minimum distance can be specified as a specified surface value, with which the corresponding distance width of the absorption strips is accordingly compared as a surface parameter. Based on this example, it can now be seen that it can be output, as a comparison result, whether or not the specified and compared surface parameters meet the specified surface value. In the simplest case, it can be decided qualitatively whether or not the bird protection function exists when the specified surface value is fulfilled. Of course, a quantitative evaluation is also possible, so that the bird protection parameter can reflect the efficiency of the bird protection function of the evaluated bird protection section.

It should also be noted that such an evaluation method can for example be directly integrated into a camera device. However, in principle, the evaluation method can also be completely separated from a camera device and can for example be server-based or cloud-based. For example, it is in principle conceivable that the verification method is carried out on site when a glass surface is recorded using the camera device. The presence of the bird protection function is thereby fundamentally demonstrated. For the subsequent qualitative and/or even quantitative evaluation, the evaluation method described here can be carried out either within the camera device or by transmitting it to a corresponding evaluation unit, and the bird protection parameter can make it possible to evaluate the bird protection function in a qualitative and/or quantitative way.

It can be advantageous if, in an evaluation method according to the invention, at least one of the following is used as surface parameter:
form
contour
distance
surface area.

The above list is a non-exhaustive list. Of course, combinations of different surface parameters can also be used. As can be seen from the example of this evaluation method with regard to the width of absorption strips, different surface parameters relate to correspondingly specific associated specified surface values, which can be absolute specified values, relative specified values or limit ranges of specified values.

Further advantages can be achieved if, in an evaluation method according to the invention, in addition to the surface parameters, a comparison of at least one optical parameter of the identified UV absorption sections and/or the identified UV reflection sections with at least one specified optical value takes place. In addition to the fact that a shape evaluation, preferably automated, can now be carried out in a range that is not visible to humans, the optical functional effect can also be taken into account in such an evaluation method. For example, the individual wavebands and their effectiveness or perceptibility by the birds can be determined. In particular, it is possible to divide absorption and/or reflection into different UV sub-ranges such as UVA or UVB, so that, accordingly, a qualitative significance can be provided here with different optical effects. A contrast effect between different degrees of absorption, reflection and/or transmission in the UV range can also be compared as an optical parameter with the corresponding specified optical value. Here too, a quantitative assessment can take place in addition to a qualitative evaluation.

In addition, it can also bring advantages if, in an evaluation method according to the invention, absolute specified values are, at least in some cases, used as specified values. In the example of the strip width already mentioned, a maximum width and/or a minimum width for strips in mm and a maximum and/or minimum width for the distance between the strips can be specified. In particular, no reference to environmental information or the reference section, explained later, is necessary here.

It is also advantageous if, in an evaluation method according to the invention, at least one reference section is used for comparison, in particular as part of the bird protection image. Thus, for example, the reference section can preferably provide a specified value relativised in this way as a specified surface value and/or specified optical value. In both cases, the respective specified values are captured from the bird protection image and the reference section arranged therein. Of course, this also applies in the same way if the reference section can be specified by a separate camera recording in the form of the reference recording already explained. Last but not least, in addition or alternatively, the reference parameters already explained can also be taken into consideration here.

It can also be advantageous if, in an evaluation method according to the invention, the comparison result is output in the form of a quantitative bird protection parameter. Such a quantitative bird protection parameter can for example include the degree of optical contrast, the measurements of the pattern, the distance from the width limits of absorption strips or the like. This makes it possible to specify a quantitative function and thus, for example, a bird protection parameter in percentages, i.e. how well the bird protection function is actually manifested on the current and specific glass surface and how it acts.

It brings further advantages if, in such an evaluation method, the following step is in addition carried out:
capturing a bird protection image of a glass surface with at least one bird protection section effective in the visible range.

In addition to a version with a bird protection section which is effective solely in the UV range, the evaluation can also be carried out on bird protection functions that are recognisable in the visible range. While a verification method according to the invention is not necessary for bird protection sections which are effective in the visible range, since they can be directly perceived by the human eye, a further development of the evaluation method with a preferably automatic evaluation of the bird protection section which is also effective in the visible range likewise brings the same advantages as have been explained with reference to the UV range. The corresponding protection function can in particular be combined in the form of two bird protection parameters to form an overall bird protection parameter or added together in a simple way.

The subject matter of the present invention also includes a computer program product comprising commands which, when the program is run on a computer, cause it to carry out the evaluation method according to the present invention. Thus, a computer program product according to the invention brings the same advantages as have been explained in detail with reference to an evaluation method according to the invention.

A further subject matter of the present invention is a camera device for use in a verification method according to the invention. Such a camera device has an optical sensor device for generating a camera recording and an optical lens arrangement with a recording direction for guiding incident light rays onto the optical sensor device. The beam path through the optical lens arrangement to the optical sensor device is free of a UV protection filter. Furthermore, a UV transmission filter device is arranged in this beam path to limit the spectrum of the light beam incident on the optical sensor device to the UV range. When used in a verification method according to the invention, a camera device according to the invention brings the same advantages as have been explained in detail with reference to a verification method according to the invention. The optical sensor device can also be described as an optical chip. The term UV transmission refers in particular to the UVA range, but can also be broader. For example, in particular in the interchangeable version to be explained below, a UV transmission filter device can be designed for different UV sub-ranges, for example as a UVA transmission filter device or as a UVB transmission filter device. The UV transmission filter device preferably has a high transmittance in the UV range in order to be able to bring the highest possible brightness to the UV radiation impinging on the optical sensor device.

Such a camera device can be further developed in such a way that the UV transmission filter device is reversibly attached to allow an exchange with a VIS transmission filter device for limiting the spectrum of light rays incident on the optical sensor device to the visible range. This is particularly useful if the bird protection section is effective both in the UV range and in the VIS (“visible”) range that is visible to humans.

It can also be advantageous if, in a camera device according to the invention, the UV transmission filter device is arranged in the beam path before the optical lens arrangement. This makes it easily accessible outside the lens arrangement and, in particular if attached reversibly, it can be easily and quickly exchanged with other UV transmission filter devices or the aforementioned VIS transmission filter device.

It also brings advantages if, in a camera device according to the invention, a mounting device for a reference section is provided in the area of the recording direction. This makes it possible to attach the reference section to the camera device, so that it can be easily and quickly integrated into the camera recording when generating this.

Further advantages, features and details of the invention are explained in the following description, in which exemplary embodiments of the invention are described in detail with reference to the drawings. The features mentioned in the claims and in the description may in each case be essential to the invention individually or in any combination. In each case schematically:

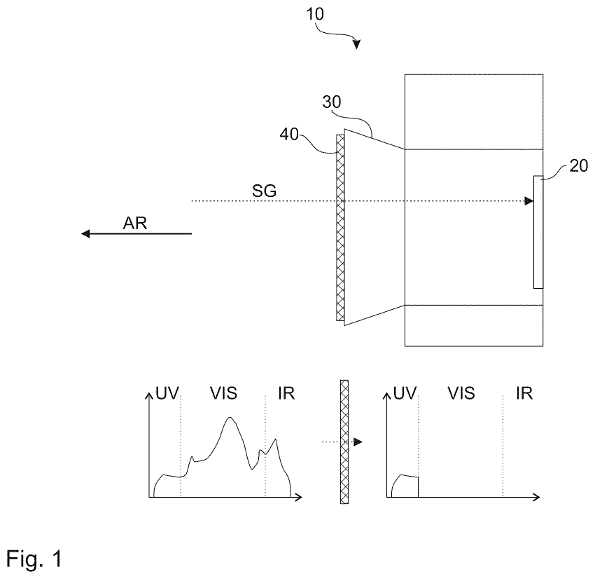

FIG. 1 shows an embodiment of a camera device according to the invention,

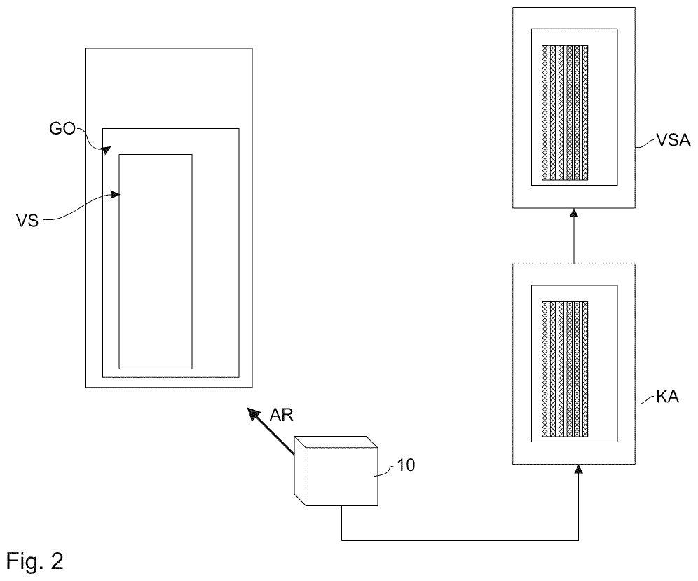

FIG. 2 shows a performance of a verification method according to the invention,

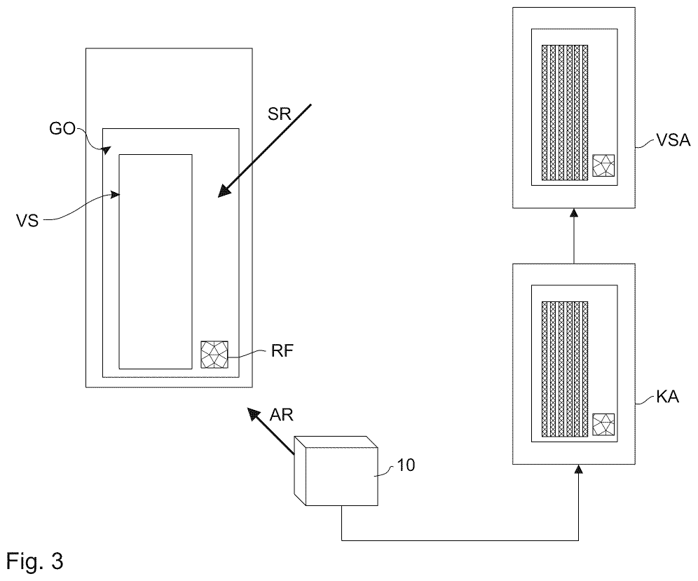

FIG. 3 shows a further performance of a verification method according to the invention,

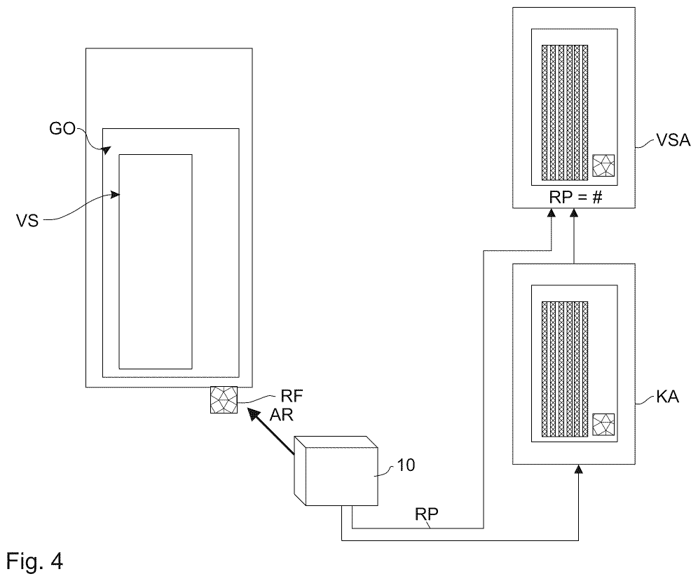

FIG. 4 shows a further performance of a verification method according to the invention,

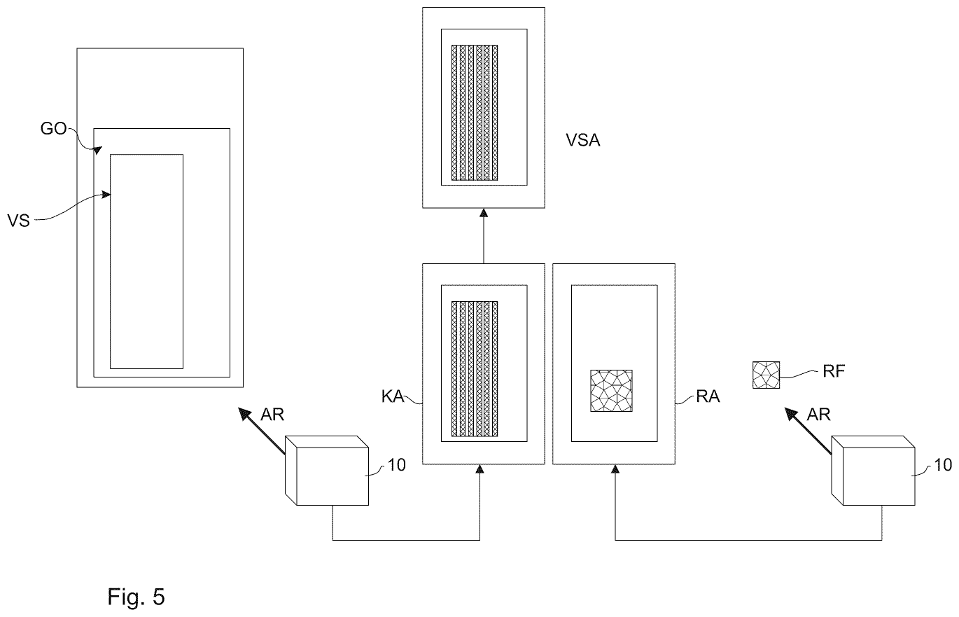

FIG. 5 shows a verification method with subsequent reference recording,

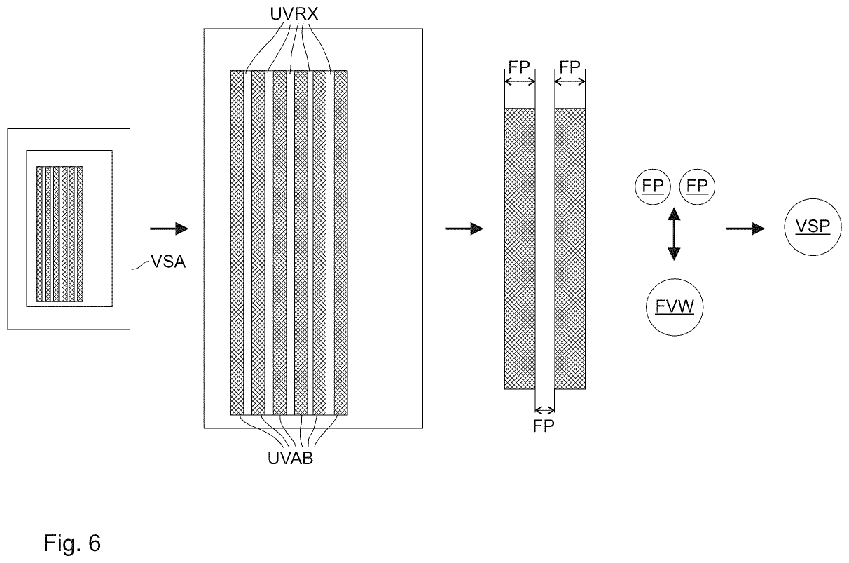

FIG. 6 shows a possibility of an evaluation method according to the invention,

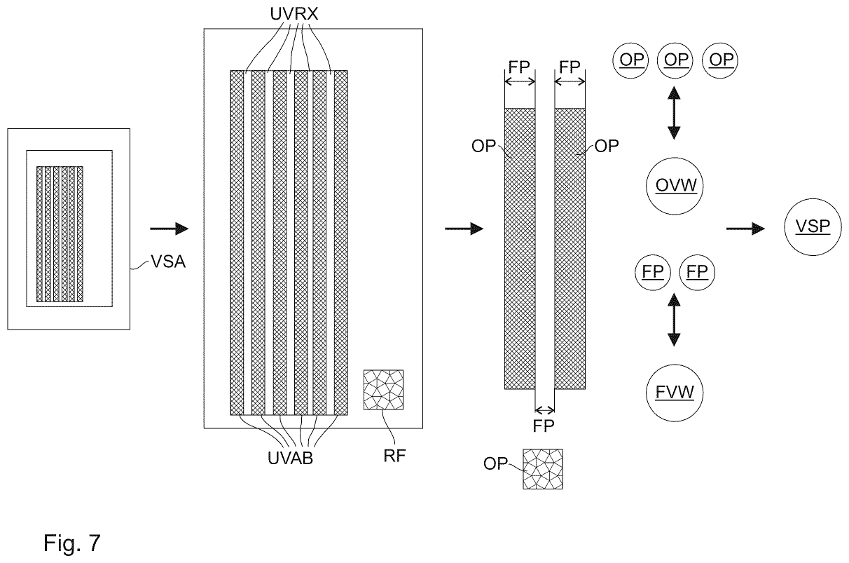

FIG. 7 shows a further possibility of an evaluation method according to the invention,

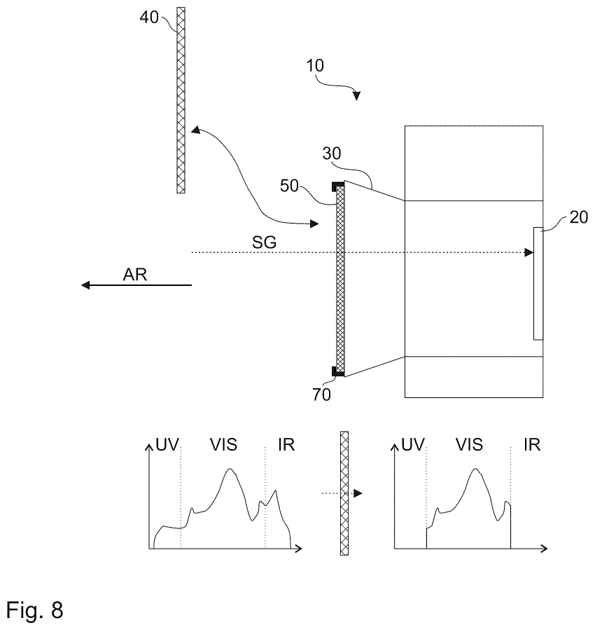

FIG. 8 shows a further possibility of a camera device according to the invention and

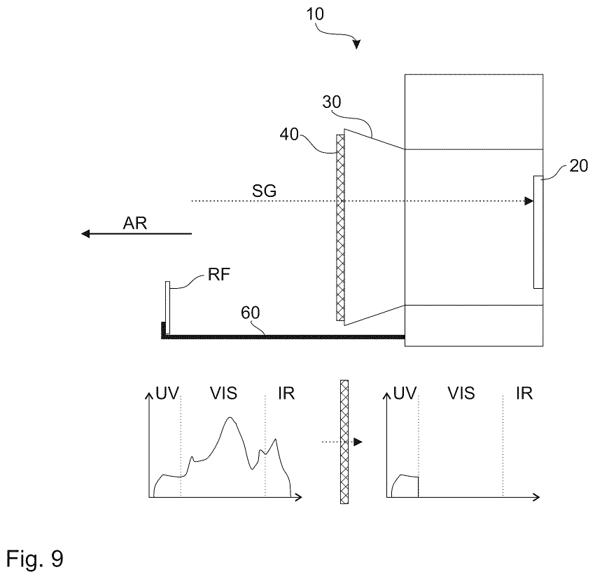

FIG. 9 shows a further embodiment of a camera device according to the invention.

FIG. 1 shows schematically a particularly simply designed camera device 10 according to the invention. This is designed here as a digital camera device 10 and is equipped with a corresponding digital imaging chip as optical sensor device 20. In order for this optical sensor device 20 to be able to record light rays, an optical lens arrangement 30 is arranged upstream in the beam path SG of this optical sensor device 20. Of course, this can be equipped with an aperture device, mirror devices or the like. In effect, the optical lens arrangement 30 causes incident light along the beam path SG to pass through the optical lens arrangement 30 to the optical sensor device 20. Here, the UV transmission filter device 40 is arranged on the outside, i.e. before the optical lens arrangement 30 in the beam path SG, in this way also defining the recording direction AR of the camera device 10 with reference to the beam path SG.

The mode of operation of this camera device 10 is shown schematically at the bottom of FIG. 1. Thus, light enters across the entire spectrum, in the UV range, in the VIS (visible) range and in the IR (infrared) range. However, all components of this spectrum that do not belong to the UV range are absorbed or reflected by the UV transmission filter 40. Accordingly, after the UV transmission filter device 40, only the UV components of the light spectrum pass further along the beam path SG to the optical sensor arrangement 20.

The verification method is represented schematically in FIG. 2. The camera device 10 is aligned with the recording direction AR in the direction of a glass surface GO, for example part of a glass facade of a building. This means that the camera device 10 is able to generate a camera recording KA which represents a representation and reproduction of the glass surface GO. In reality, a bird protection section VS is now arranged as a film on the glass surface GO, for example by adhesive means. In reality, this is not visible in FIG. 2, since in terms of its optical effect the bird protection function is formed in the UV range, so that the bird protection section VS cannot be perceived by humans. Due to the fact that, with the help of the UV transmission filter device 40 of the camera device 10, a changed perception can now be achieved on the optical sensor device 20 in the camera device 10 compared to human visible perception, a camera recording KA is generated as shown in FIG. 2. The camera recording KA thus forms a reproduction such as is for example included in the perception of birds. In the camera recording KA, the individual absorption strips with their absorption effect in the UV range are therefore recognisable as part of the bird protection section VS. Thus, a proof and visualisation of this bird protection function and the bird protection section VS can be provided by outputting this camera recording KA as a bird protection image VSA.

FIG. 3 shows possible further developments of such a method. On the one hand, the recording direction AR is aligned with a direction of reflection of the sky from the glass surface GO and is in addition aligned with respect to a direction of incident sunlight SR. This direction of incident sunlight SR is now correlated with a correspondingly desired recording direction AR, so that the desired and thus in particular comparable optical effect can be achieved for an evaluation preferably to be carried out later. FIG. 3 also shows a reference section RF. Here, this is arranged, for example by adhesive means, on the glass surface GO parallel to the bird protection section VS. This means that the reference section RF becomes part of the camera recording KA and accordingly is also output as part of the bird protection image VSA. This makes it possible for example to provide a control function as to whether the camera device 10 can actually reproduce the UV effects known from the reference section RF, and accordingly a lack of an assigned UV effect on the glass surface GO corresponds to a lack of the bird protection function.

With regard to the reference section RF, FIG. 4 basically corresponds to the functionality shown in FIG. 3. However, here the reference section RF is located not on the glass surface GO but parallel thereto, in front of it, so that a similar effect can however be achieved in the arrangement in the camera recording KA. The camera device 10 can for example register the light intensity or the like with the help of light sensors and in this way pass on a reference parameter RP. In this exemplary embodiment, this is output as part of the bird protection image VSA.

FIG. 5 also allows a referencing, but independently of the camera recording KA. Rather, a reference recording RA of only the reference section RF, without the glass surface GO, is generated here, preferably using the same camera device 10. This makes it possible either to integrate this reference recording RA into the bird protection image VSA, which is not shown here, or to use the reference recording RA as an additional basis for the later evaluation method.

FIG. 6 shows schematically one possibility of an evaluation method. Based on a bird protection image VSA, as has been explained by way of example with reference to the previous figures, the first step here is to identify UV absorption sections UVAB and UV reflection sections UVRX. The sections differ in their optical effect in the UV range. In the next step, after identifying these different sections which are effective in the UV range, a surface parameter FP, in this case the width of the absorption strips and the gap width between the absorption strips, is recorded as two surface parameters FP and compared with one or more specified surface values FVW in the last step. Finally, the bird protection parameter VSP can be output, in the simplest way qualitatively, stating whether or not the specified surface value FVW is fulfilled. However, a quantitative output, in particular the detected distance, from a quantitative point of view, between the surface parameters FP and the specified surface value FVW is also possible.

In FIG. 7, optical parameters OP, with comparison with a specified optical value OVW, are in addition part of the evaluation method. This can for example be the absorption rates of the individual absorption strips of the UVAB. On the other hand, a reference section RF is provided here. An optical parameter OP can also be recorded for this which is either also included in the comparison with the specified optical value OVW or, alternatively, itself provides a specified optical value relativised in this way.

FIG. 8 shows another further development of a camera device 10. This is equipped here with a reversibly attached UV transmission filter device 40, which has been exchanged here with a VIS transmission filter device. The VIS transmission filter device has a different effect here than the UV transmission filter device 40. Here, the

UV range and the IR range are filtered out, so that only a part of the light spectrum in the VIS range, i.e. in the range visible to humans, passes through the optical lens arrangement 30 to the optical sensor device 20.

In FIG. 9, the camera device 10 is also equipped with a mounting device 60 which allows a reference section RF to be arranged. This can of course be combined with a filter mounting device 70 according to FIG. 8.

The above explanation of the embodiments describes the present invention exclusively in the context of examples. Of course, individual features of the present embodiments can, if technically expedient, be freely combined with each other without departing from the scope of the present invention.

### LIST OF REFERENCE SIGNS

10 camera device
20 optical sensor device
30 optical lens arrangement
40 UV transmission filter device
50 VIS transmission filter device
60 mounting device
70 filter mounting device
AR recording direction
SR direction of incident sunlight
SG beam path
KA camera recording
RA reference recording
RF reference section
RP reference parameter
GO glass surface
VS bird protection section
UVAB UV absorption section
UVRX UV reflection sections
FP surface parameter
OP optical parameter
FVW specified surface value
OVW specified optical value
VSP bird protection parameter
VSA bird protection image
UV ultraviolet range of a light spectrum
VIS visible range of a light spectrum
IR infrared range of a light spectrum

1. Verification method for verifying a bird protection function of a glass surface (GO) with at least one bird protection section (VS) that is effective at least in the UV range, comprising the following steps:
aligning a recording direction (AR) of a camera device with a UV transmission filter device onto the glass surface (GO),
generating at least one camera recording (KA) of the glass surface (GO) with the bird protection section (VS) by means of the aligned camera device,
outputting at least one camera recording (KA) as a bird protection image (VSA) as proof of the bird protection function provided by the bird protection section (VS) visible in the bird protection image (VSA).

2. Verification method according to claim 1, wherein the recording direction (AR) is aligned with a direction of reflection of the sky from the glass surface (GO).

3. Verification method according to claim 1, wherein the recording direction (AR) is in addition aligned with respect to a direction of incident sunlight (SR) onto the glass surface (GO).

4. Verification method according to claim 1, wherein a reference section (RF) is placed in a recording area of the aligned camera device which, when the camera recording (KA) is generated, is part of this camera recording (KA).

5. Verification method according to claim 4, wherein at least one of the following is used as reference section (RF):
mirror section
glass section
colour section.

6. Verification method according to claim 4, wherein the reference section (RF) is aligned parallel or substantially parallel to the glass surface (GO).

7. Verification method according to claim 1, wherein at least one reference parameter (RP) is recorded for at least one camera recording (KA).

8. Verification method according to claim 1, wherein in addition to the bird protection image (VSA), a camera recording (KA) of a reference section (RF) is generated and is output as a reference recording (RA).

9. Evaluation method for a bird protection function of a bird protection section (VS) on the basis of a bird protection image (VSA), in particular generated using a verification method having the features of claim 1, comprising the following steps:
recording the bird protection image (VSA) of a glass surface (GO) with at least one bird protection section (VS) effective at least in the UV range,
identifying UV absorption sections (UVAB) and/or UV reflection sections (UVRX) in the bird protection image (VSA),
comparing at least one surface parameter (FP) of the identified UV absorption sections (UVAB) and/or the identified UV reflection sections (UVRX) with at least one specified surface value (FVW),
outputting the comparison result as a bird protection parameter (VSP) for the bird protection function of the bird protection section (VS).

10. Evaluation method according to claim 9, wherein at least one of the following is used as surface parameter (FP):
form
contour
distance
surface area.

11. Evaluation method according to claim 9, wherein, in addition to the surface parameters (FP), a comparison of at least one optical parameter (OP) of the identified UV absorption sections (UVAB) and/or the identified UV reflection sections (UVRX) with at least one specified optical value (OVW) takes place.

12. Evaluation method according to claim 9, wherein absolute specified values are, at least in some cases, used as specified values.

13. Evaluation method according to claim 9, wherein at least one reference section (RF) is used for the comparison, in particular as part of the bird protection image (VSA).

14. Evaluation method according to claim 9, wherein the comparison result is output in the form of a quantitative bird protection parameter (VSP).

15. Evaluation method according to claim 9, wherein the following step is in addition carried out:
capturing a bird protection image (VSA) of a glass surface (GO) with at least one bird protection section (VS) effective in the visible range.

16. Computer program product comprising commands which, when this program is run on a computer, cause this to carry out the evaluation method with the features of claim 9.

17. Camera device for use in a verification method having the features of claim 1, comprising an optical sensor device for generating a camera recording (KA) and an optical lens arrangement having a recording direction (AR) for guiding incident light rays onto the optical sensor device, wherein the beam path (SG) through the optical lens arrangement to the optical sensor device is free of a UV protection filter, and a UV transmission filter device is further arranged in the beam path (SG) to limit the spectrum of the light rays incident on the optical sensor device to the UV range.

18. Camera device according to claim 17, wherein the UV transmission filter device is reversibly attached to allow an exchange with a VIS transmission filter device for limiting the spectrum of light rays incident on the optical sensor device to the visible range.

19. Camera device according to claim 17, wherein the UV transmission filter device is arranged in the beam path (SG) before the optical lens arrangement.

20. Camera device according to claim 17, wherein a mounting device for a reference section (RF) is provided in the area of the recording direction (AR).
